(19) United States
(12) Patent Application Publication
(10) Pub. No.: US 2017/0135332 A1
(43) Pub. Date: May 18, 2017

(54) COLLAPSIBLE WHEELED GAME TRANSPORT CART WITH CARRYING STRAPS

(71) Applicant: Keith A. Doyle, Concord, NC (US)

(72) Inventor: Keith A. Doyle, Concord, NC (US)

(21) Appl. No.: 15/353,354

(22) Filed: Nov. 16, 2016

Related U.S. Application Data
(60) Provisional application No. 62/256,539, filed on Nov. 17, 2015.

(51) Int. Cl. A01M 31/00; B62B 1/20; B62B 5/06; B62B 1/22

(52) U.S. Cl. CPC A01M 31/006; B62B 1/22; B62B 1/208; B62B 5/068; B62B 2202/42

(57) ABSTRACT

A collapsible wheeled game transport cart is disclosed. The game transport cart includes carrying straps that are used to transport the cart when it is unloaded and collapsed. Straps for securing game to the game transport cart may be provided, and the cart is easily navigated over rough and wooded terrain. A collapsible kickstand may be provided that facilitates loading, transporting and unloading of game.

### CROSS-REFERENCE TO RELATED APPLICATION

This application claims the benefit of U.S. Provisional Patent Application Ser. No. 62/256,539 filed Nov. 17, 2015, which is incorporated herein by reference.

### FIELD OF THE INVENTION

The present invention relates to game transport carts, and more particularly relates to collapsible wheeled game transport carts having carrying straps, game securing straps and kickstands.

BACKGROUND INFORMATION

The use of game transporting devices is known. While many prior configurations have been devised for the purpose of transporting game carcasses, each possesses disadvantages that may be overcome by the present invention. Some of the earlier devices are generically referred to as carts, while others are combinations of devices useful to a hunter, such as a combined tree stand and cart, or a combined ladder and cart. Common disadvantages of these devices include bulky construction making the carts heavy and large in size and not easily transportable into remote areas, complexity of assembly making the carts more difficult to deploy in the dark or in adverse outdoor weather conditions, lack of means for carrying the carts when unloaded, and excessive handle weight when transporting loaded carts.

An example of a collapsible game transporting device is described in published U.S. Patent Application Publication No. 2004/0130112, which is incorporated herein by reference.

### SUMMARY OF THE INVENTION

The present invention provides wheeled devices for use by hunters in transporting heavy game from remote areas with rough and wooded terrain, e.g., where there is limited or no motor vehicle access. A simple, collapsible, lightweight, wheeled game transporting device with carrying straps is provided that is easily carried into a remote area when empty and facilitating removal of a game carcass out of a remote area when deployed. The game transporting cart includes carrying straps and is small in size and light in weight so that it is easily carried as a backpack when collapsed. A simple collapsible design is provided that may easily be assembled in the dark or in adverse outdoor weather conditions. Straps for securing a game carcass to the game transporting cart may be provided, and the cart is easily navigated over rough and wooded terrain. A collapsible kickstand may be provided as part of the game transporting cart that facilitates loading, transporting and/or unloading of game.

An aspect of the present invention is to provide a collapsible game transport cart comprising a base, a lower section attached to the base, an upper section hinged to the lower section, a wheel mounted on the base, and at least one shoulder strap connected to a least one of the lower and upper sections, wherein the lower and upper sections are movable in relation to each other from an extended position to a collapsed position, and the at least one shoulder strap is structured and arranged to be carried over a shoulder of a user when the lower and upper sections are in the collapsed position.

Another aspect of the present invention is to provide a collapsible game transport cart comprising a base, a lower section attached to the base, an upper section hinged to the lower section, a wheel mounted on the base, and a collapsible kickstand attached to the upper section of the cart.

These and other aspects of the present invention will be more apparent from the following description.

### BRIEF DESCRIPTION OF THE DRAWINGS

FIG. 1 is an isometric view of a collapsible wheeled game transport cart including shoulder straps and game-securing straps in accordance with an embodiment of the present invention.

FIG. 2 is a back view of the collapsible wheeled game transport cart of FIG. 1.

FIG. 3 is a back view of a collapsible wheeled game transport cart similar to the embodiment shown in FIGS. 1 and 2, with the addition of a shoulder harness in accordance with an embodiment of the present invention.

FIG. 4 is a side view of a collapsible wheeled game transport cart in accordance with an embodiment of the present invention.

FIG. 5 is an isometric view of a collapsible wheeled game transport cart in a collapsed configuration in accordance with an embodiment of the present invention.

FIG. 6 is a back view and FIG. 7 is a side view of the collapsed wheeled game transport cart of FIG. 5.

FIG. 8 is a bottom isometric view of a portion of a collapsible wheeled game transport cart including kickstands in accordance with an embodiment of the present invention.

FIG. 9 is a back view of a collapsible wheeled game transport cart including shoulder harnesses in accordance with an embodiment of the present invention.

### DETAILED DESCRIPTION

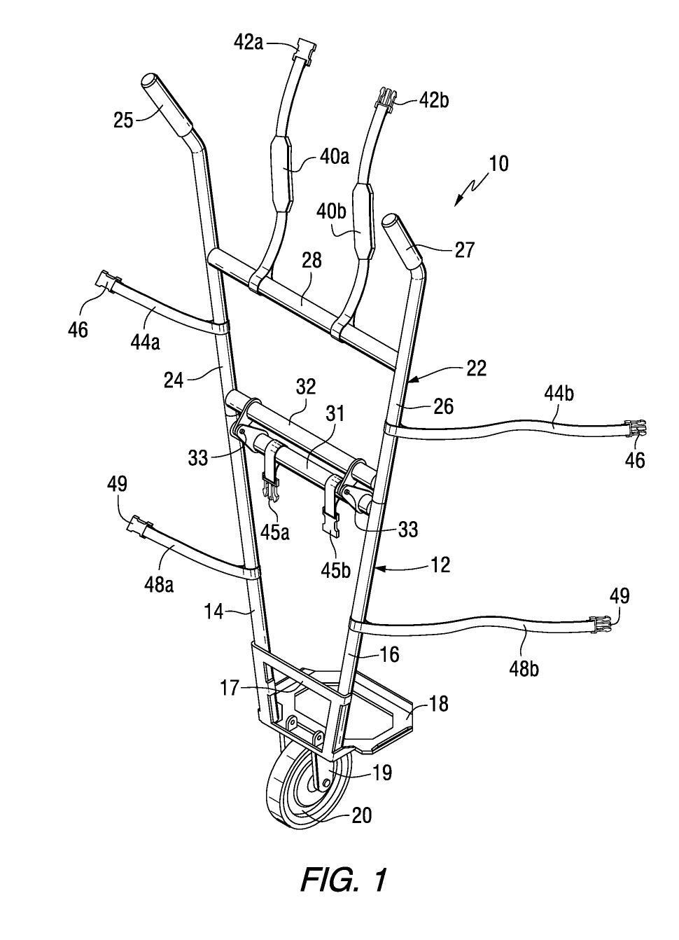

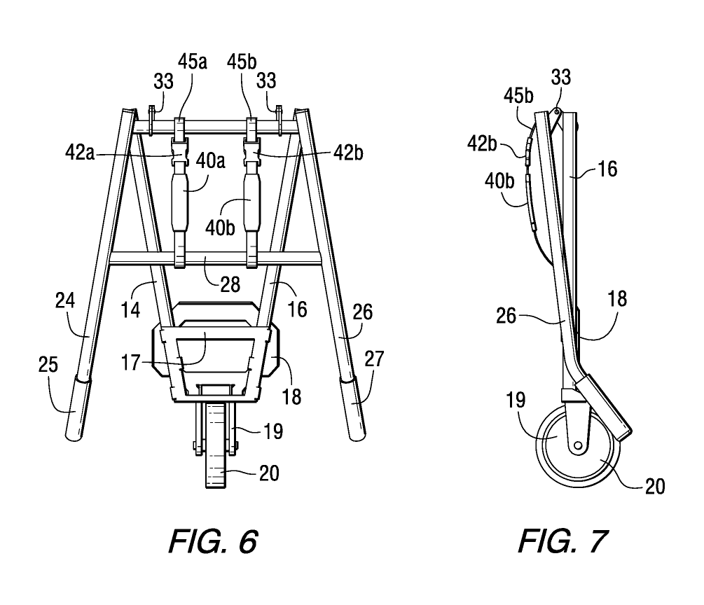

FIGS. 1-9 illustrate collapsible wheeled game transport carts in accordance with embodiments of the present invention. The collapsible game transport cart 10 includes a lower section 12 and an upper section 22 forming a two-section foldable frame. In FIGS. 1-4, 8 and 9, the lower and upper sections 12 and 22 are in their extended or deployed positions for hauling game. In FIGS. 5-7, the lower and upper sections 12 and 22 are in their folded or collapsed positions for carrying the unloaded cart.

The lower section 12 includes a first side rail 14 and second side rail 16 attached to a base 17 comprising a skid plate. A collapsible bottom support plate 18 is pivotally attached to the skid plate base 17. As shown in FIGS. 5-7, the collapsible bottom support plate 18 may be folded or collapsed against the skid plate 17 to provide a low-profile, compact configuration for transport purposes.

The upper section 22 includes a first side rail 24 and second side rail 26 with a central game support bar 28 extending therebetween. Handles 25 and 27 are provided at the upper ends of the first and second side rails 24 and 26. In the embodiment shown, the handles 25 and 27 comprise a substantially straight bar or tube that is angled with respect to their respective first and second side rails 24 and 26. This arrangement provides an ergonomic hand grip configuration for transporting game while providing a relatively low side profile for carrying the game transport cart 10 in its collapsed configuration.

The lower and upper sections 12 and 22 are hinged together by means of a lower section crossbar 31 extending between the first and second lower side rails 14 and 16, an upper section crossbar 32 extending between the first and second upper side rails 24 and 26, and hinges 33 mounted on the crossbars 31 and 32. As shown by comparing FIGS. 1-4 with FIGS. 5-7, the hinges 33 allow the lower and upper sections 12 and 22 to fold into a collapsed configuration approximately one-half the height of the extended or deployed position. For example, the collapsed height of the cart may be from 40 percent to 60 percent of the extended height of the cart, such as about 50 percent of the extended height. This bi-fold arrangement provides a cart that is suitably sized for transporting relatively large game such as deer, while providing a collapsed height that may be conveniently carried as a backpack. In addition to a convenient carrying height, the collapsed cart 10 has a low side profile which facilitates carrying of the collapsed cart without excessive bulkiness.

In the fully collapsed state, the game cart 10 may thus be reduced to approximately one-half of its extended length and the frame resembles that of a backpack frame. As more fully described below, game securing straps may be used to secure the cart 10 in the fully collapsed position, and carrying straps enable the cart 10 to be carried as a backpack. Due to its light weight, e.g., less than 12-15 pounds, the cart 10 is easily transportable in the collapsed configuration.

As shown in FIGS. 1, 2 and 5-7, the game transport cart 10 may include a first shoulder strap 40a and second shoulder strap 40b attached to the central game support bar 28 of the upper section 22. A first shoulder strap buckle 42a is provided at the end of the first shoulder strap 40a, and a second shoulder strap buckle 42b is provided at the end of the second shoulder strap 40b. In the embodiment shown, the first and second shoulder strap buckles 42a and 42b are provided as engageable female and male components, however, any other suitable type of buckle or fastener arrangement may be used.

As further shown in FIGS. 1, 2 and 5-7, first and second opposing shoulder strap buckles 45a and 45b are attached to the lower section crossbar 31. As shown in FIGS. 5-7, when the cart is in the collapsed position for carrying as a backpack, the first shoulder strap buckle 42a engages with the first opposing shoulder strap buckle 45a, and the second shoulder strap buckle 42b engages with the second opposing shoulder strap buckle 45b. In this configuration, the first and second shoulder straps 40a and 40b may be placed over a user's shoulders for carrying purposes similar to a backpack. The first and second shoulder straps 40a and 40b may be slidably mounted on the central game support bar 28 in order to allow for adjustment of their positions depending on the size of the user. The first and second opposing shoulder strap buckles 45a and 45b may be slidably mounted on the lower section crossbar 31 to allow for size adjustments. In the embodiment shown, the first and second shoulder straps 40a and 40b are adjustable and padded in order to increase wearer comfort. However, any other suitable type of padded or non-padded shoulder straps may be used. Thus, the present invention provides two parallel backpack-style shoulder straps attached in a vertical configuration for transportation into and out of remote hunting areas while in the folded state. The backpack style straps may be fully adjustable to fit the user.

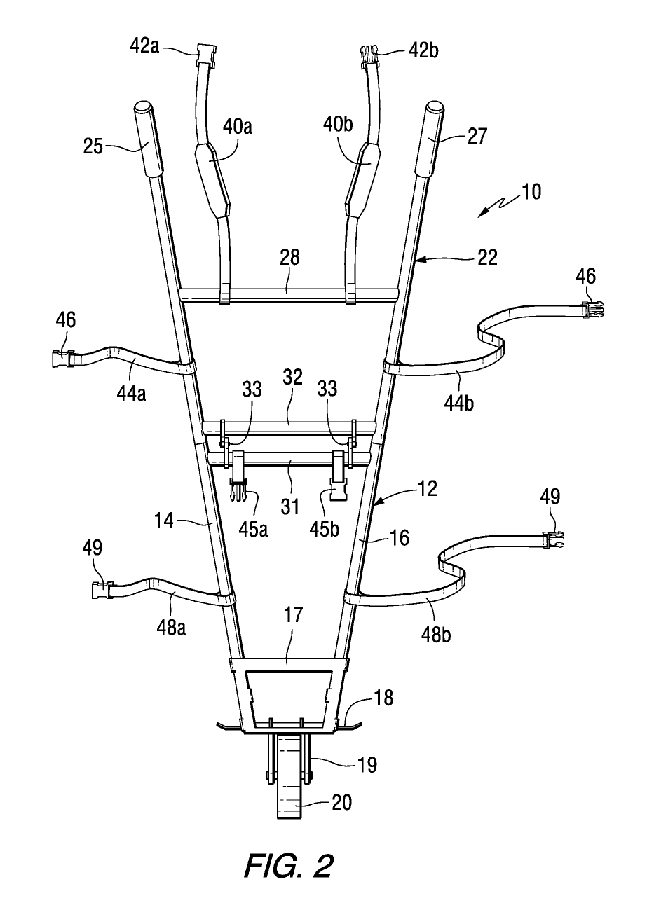

As shown in FIGS. 1 and 2, the game transport cart 10 may include straps for securing game when loaded on the cart. In the embodiment shown, first and second upper game securing straps 44a and 44b are slidably mounted on the first and second upper side rails 24 and 26. The first and second upper game securing straps 44a and 44b may be releasably engaged with each other by a buckle 46. As further shown in FIGS. 1 and 2, first and second lower game securing straps 48a and 48b are slidably mounted on the first and second lower side rails 14 and 16. A buckle 49 may be used to releasably secure the ends of the first and second lower game securing straps 48a and 48b together. The upper game securing straps 44a and 44b and lower game securing straps 48a and 48b may be positioned along their respective side rails at selected locations that facilitate game securement during transport. In addition, during game transport, the first and second shoulder straps 40a and 40b may be used to further secure game to the cart. For example, the first and second shoulder straps 40a and 40b may be releasably connected to each other by means of the shoulder strap buckle 42a, 42b in order to secure the neck or head of a deer or other large game, while the upper game securing straps 44a and 44b and lower game securing straps 48a and 48b may be used to secure the body of the game.

In the fully extended and deployed state, the game cart 10 may have a ladder-like frame on which game can be loaded and supported. The extended frame may be essentially trapezoidal in shape, with the side rails 14, 16 and 24, 26 being spaced closer together at the distal end where the wheel 20 is attached and tapering to a wider spacing at the proximal end, e.g., where the handles 25 and 27 are located. When the frame is extended and game is mounted on the frame, the hinges 33 are rigidly locked into position by the weight of the game and the frame acts as one unit to provide support for the game. The handles 25 and 27 can be held at any height, and thus the cart 10 is automatically adaptable to a user of any height. The handles 25 and 27 perform equally well for a person restraining the cart from behind as it is lowered down a slope. The components of the game transport cart 10 may be made of any suitable materials, e.g., the base, side rails and crossbars may be made of strong and lightweight materials such as steel, aluminum or the like.

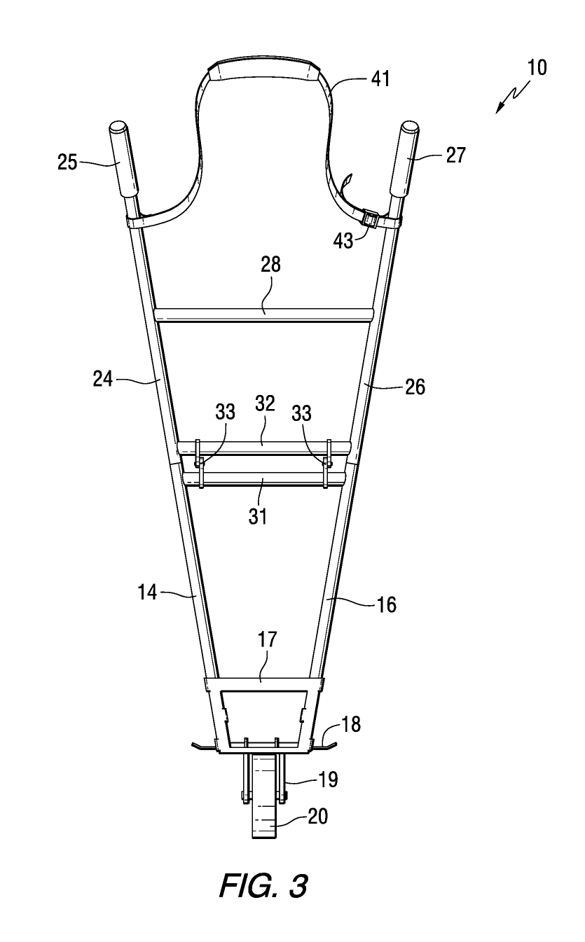

FIG. 3 illustrates another strap arrangement in accordance with an embodiment of the present invention. In this embodiment, a shoulder harness 41 including a buckle 43 may be attached at its ends to the first and second upper side rails 24 and 26. During game transport, the shoulder harness 41 may rest on the back of a user's neck and extend under the user's armpits to help shift some of the weight of the game from the handles 25 and 27 to the user's upper torso. The shoulder harness 41 may be padded and transfers the weight of the game animal from the hands of the user onto the body of the user. For example, the shoulder harness strap 41 may be about 2 inches wide and approximately 60 to 80 inches in length when fully extended. The padded portion may be approximately 18 inches in length and 4 inches wide, and may slide freely along the strap. The shoulder harness 41 may be configured with a sewn closed loop on one end and an adjustable loop on the opposite end, e.g., through the use of a tri-glide style metal buckle. The shoulder harness 41 may be fully adjustable for the height of any user.

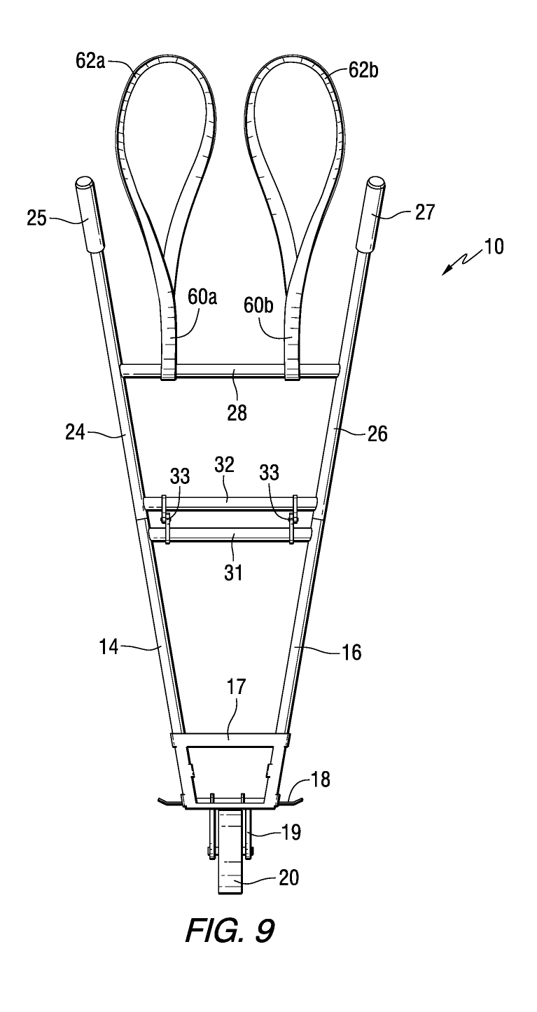

FIG. 9 illustrates a further strap arrangement in accordance with an embodiment of the present invention. In this embodiment, first and second game hauling straps 60a and 60b are attached to the central game support crossbar 28 of the upper section 22. The first and second game hauling straps 60a and 60b include first and second shoulder loops 62a and 62b. During game transport, the user's arms may be inserted through the first and second loops 62a and 62b such that the loops rest on the user's shoulders. This arrangement helps shift weight of the game from the handles 25 and 27 to the user's shoulders during transport of the loaded cart.

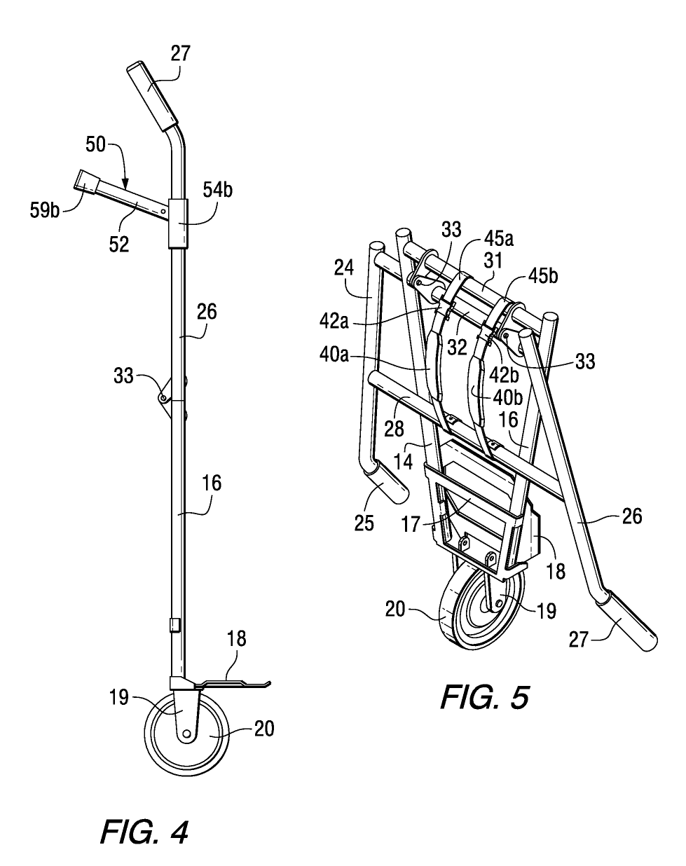

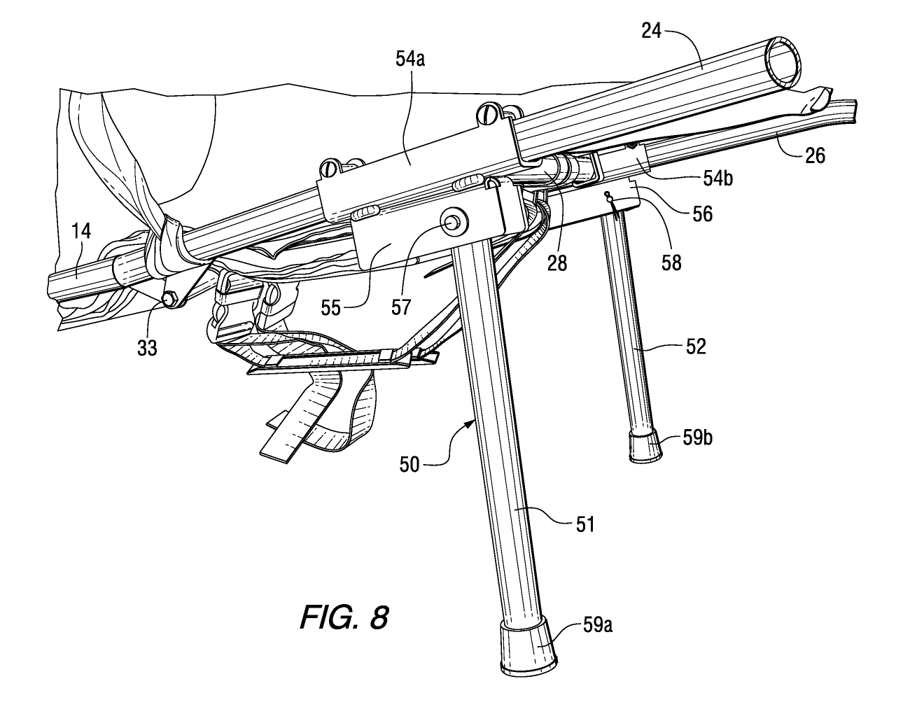

FIGS. 4 and 8 illustrate collapsible kickstands 50 mounted on the game transport cart 10 in accordance with embodiments of the invention. As most clearly shown in FIG. 8, the collapsible kickstand 50 includes first and second kickstand legs 51 and 52. A first kickstand mounting channel 54a is mounted on the first upper side rail 24, and a second kickstand mounting channel 54b is mounted on the second upper side rail 26. A first kickstand mounting bracket 55 is attached to the first kickstand mounting channel 54. The first kickstand leg 51 is rotatably mounted on the first kickstand mounting bracket 55 by a pivot mounting 57. The second kickstand leg 52 is rotatably mounted on the second kickstand mounting bracket 56 by a second pivot mounting 58. A first foot cap 59a is mounted on the end of the first kickstand 51, and a second foot cap 59b is mounted on the end of the second kickstand leg 52. The kickstand legs 51 and 52 may be pivoted into their extended or deployed positions shown in FIG. 8 in order to support the upper section 22 at an angled position above the ground when game is being loaded onto the cart. For example, when the kickstand legs 51 and 52 are extended, the side rails 14, 16, 24 and 26 may be oriented at an angle of from 5° to 40°, or from 10° to 30°, measured from the horizontal ground. The elevated position provided by the kickstand 50 facilitates initial lifting of the loaded transport cart during hauling operations. The kickstand 50 may thus be used to elevate the game cart 10 from the ground to ease the initial lifting of the weighted cart, as well as to allow the user to rest with less effort. The collapsible kickstand legs 51 and 52 may fold backwards, toward the wheeled end of the frame, to allow for compact stowage.

The present invention provides a maneuverable and rugged game transport cart with carrying straps that is light in weight and collapsible and can be carried as a backpack. Further, the cart is simple and easy to assemble, and includes carrying straps that provide integral means for securing game for increased stability when fully loaded. The cart may particularly be used for the transport of deer or other like-sized game out of remote hunting areas, but its use is not restricted to such uses.

Whereas particular embodiments of this invention have been described above for purposes of illustration, it will be evident to those skilled in the art that numerous variations of the details of the present invention may be made without departing from the invention as defined in the appended claims.

What is claimed is:

1. A collapsible game transport cart comprising:
a base;
a lower section attached to the base;
an upper section hinged to the lower section;
a wheel mounted on the base; and
at least one shoulder strap connected to a least one of the lower and upper sections, wherein the lower and upper sections are movable in relation to each other from an extended position to a collapsed position, and the at least one shoulder strap is structured and arranged to be carried over a shoulder of a user when the lower and upper sections are in the collapsed position.

2. The collapsible game transport cart of claim 1, wherein the lower section comprises first and second lower side rails and a lower section crossbar extending therebetween, and the upper section comprises first and second upper side rails and a central game support bar extending therebetween.

3. The collapsible game transport cart of claim 2, wherein the at least one shoulder strap is connected at an end thereof to the lower section crossbar and at another end thereof to the central game support bar.

4. The collapsible game transport cart of claim 3, comprising two of the shoulder straps.

5. The collapsible game transport cart of claim 4, wherein a first one of the shoulder straps comprises a first shoulder strap buckle connected to the central game support bar and a first opposing shoulder strap buckle connected to the lower section crossbar and releasably engageable with the first shoulder strap buckle, and wherein a second one of the shoulder straps comprises a second shoulder strap buckle connected to the central game support bar and a second opposing shoulder strap buckle connected to the lower section crossbar and releasably engageable with the second strap buckle.

6. The collapsible game transport cart of claim 5, wherein the first and second shoulder straps are slidably mounted on the central game support bar.

7. The collapsible game transport cart of claim 6, wherein the first and second opposing shoulder strap buckles are slidably mounted on the lower section crossbar.

8. The collapsible game transport cart of claim 5, wherein the first and second shoulder strap buckles are releasably engageable with each other to form a game securing strap.

9. The collapsible game transport cart of claim 2, further comprising a first lower game securing strap connected to the first lower side rail, a second lower game securing strap connected to the second lower side rail, and a lower game securing buckle releasably securing the first and second lower game securing straps together.

10. The collapsible game transport cart of claim 9, wherein the first lower game securing strap is slidably mounted on the first lower side rail, and the second lower game securing strap is slidably mounted on the second lower side rail.

11. The collapsible game transport cart of claim 2, further comprising a first upper game securing strap connected to the first upper side rail, a second upper game securing strap connected to the second upper side rail, and an upper game securing buckle releasably securing the first and second upper game securing straps together.

12. The collapsible game transport cart of claim 11, wherein the first upper game securing strap is slidably mounted on the first upper side rail, and the second upper game securing strap is slidably mounted on the second upper side rail.

13. The collapsible game transport cart of claim 1, wherein the cart has an extended height when the lower and upper sections are in the extended position and a collapsed height when the lower and upper sections are in the collapsed position, and the collapsed height is from 40 to 60 percent of the extended height.

14. The collapsible game transport cart of claim 1, further comprising a collapsible kickstand attached to the cart.

15. The collapsible game transport cart of claim 14, wherein the collapsible kickstand is attached to the upper section of the cart.

16. The collapsible game transport cart of claim 15, wherein the kickstand is connected to a side rail of the upper section.

17. The collapsible game transport cart of claim 15, wherein the kickstand comprises a first collapsible leg pivotally mounted on a first upper side rail of the upper section and a second collapsible leg pivotally mounted on a second upper side rail of the upper section.

18. A collapsible game transport cart comprising:
a base;
a lower section attached to the base;
an upper section hinged to the lower section;
a wheel mounted on the base; and
a collapsible kickstand attached to the upper section of the cart.

19. The collapsible game transport cart of claim 18, wherein the kickstand comprises a first collapsible leg pivotally mounted on a first upper side rail of the upper section and a second collapsible leg pivotally mounted on a second upper side rail of the upper section.

20. The collapsible game transport cart of claim 19, wherein when the first and second collapsible legs are in extended positions contacting a ground surface, the first and second upper side rails are oriented at an angle of from 5° to 40° measured from the ground surface.
